(19) United States
(12) Patent Application Publication
(10) Pub. No.: US 2022/0053797 A1
(43) Pub. Date: Feb. 24, 2022

(54) COMPOSITION MANUFACTURED FROM FREEZE-DRIED EMBRYONIC SPROUTED PLANTS, AND METHODS OF MAKING AND USING THE SAME

(71) Applicant: Sharon Cryan, Buffalo, NY (US)

(72) Inventor: Sharon Cryan, Buffalo, NY (US)

(21) Appl. No.: 17/410,421

(22) Filed: Aug. 24, 2021

Related U.S. Application Data
(60) Provisional application No. 63/069,676, filed on Aug. 24, 2020.

(51) Int. Cl. A23K 10/30; A23K 30/20; A23K 40/20; A23K 40/10; A23K 50/42; A23L 3/44; A23L 19/00; A23P 30/10; A23P 10/22

(52) U.S. Cl. CPC A23K 10/30; A23K 30/20; A23K 40/20; A23K 40/10; A23K 50/42; A23V 2002/00; A23L 19/09; A23L 19/01; A23P 30/10; A23P 10/22; A23L 3/44

(57) ABSTRACT

A composition is manufactured from a freeze-dried mixture comprising one or more freeze-dried embryonic sprouted plants and one or more flavorings, such as a fruit, vegetable, or other natural or artificial flavoring. In some embodiments, the composition is molded into desired shapes and packaged. In other embodiments, the composition is not molded but pulverized into powder for reconstitution. The composition is manufactured by controlling the dry heat added, controlling the growth cycle of the embryonic sprouted plants, and including a step of freeze-drying the mixture. The food is intended to be consumed by human being or lower animals in whole or part via the oral cavity.

### CROSS REFERENCE

The present application claims priority benefit of U.S. application No. 63/069,676, filed 24 Aug. 2020, which application is incorporated herein by reference in its entirety.

### FIELD

A composition is manufactured from a freeze-dried mixture comprising one or more embryonic sprouted plants and one or more flavorings, such as a fruit, vegetable, or other natural or artificial flavoring. In some embodiments, the composition is molded into desired shapes and packaged. In other embodiments, the composition is pulverized into powder for reconstitution. The composition is manufactured by controlling the dry heat added, controlling the growth cycle of the embryonic sprouted plants, and including a step of freeze-drying the mixture. The food is intended to be consumed by human being or lower animals in whole or part via the oral cavity.

### INTRODUCTION

Freeze-drying enables the resulting product to retain sensory attributes that are important to consumers. However, freeze-drying may result in increased fragility, leading to increased breakage during shipping and handling of the product. And some purees can be difficult to freeze-dry because of their sugar content, because it is difficult to decouple the sugar and water contents.

As a further example, dissolvability is an important issue in a freeze-dried product. In particular, the product needs to remain readily dissolvable upon consumption at such a rate as to transfer flavor to the consumer's taste buds.

### SUMMARY

A composition, comprises a freeze-dried mixture of one or more embryonic sprouted plants and one or more flavorings.

In some embodiments, the embryonic spouted plants are selected from adzuki, alfalfa, broccoli, buckwheat, cabbage, cauliflower, chia, chives, clover, dill, fenugreek, flax, garbanzo bean, garlic, kale, kidney bean, lentil bean, mung bean, mustard, navy bean, oats, peas, pinto bean, pumpkin, radish, red clover, soy bean, sunflower, wheat berry, and wheat grass.

In some embodiments, the one or more flavorings is derived from a spice, fruit, fruit juice, cacao, vegetable, vegetable juice, essential oil, edible yeast, herb, bark, bud, root, leaf, meat, seafood, poultry, eggs, dairy products, fermentation products, liquid smoke, or any other natural or artificial flavoring.

In some embodiments, the composition is a food product for human or animal consumption. In some embodiments, the food product is a cereal, snack product, pudding, baby food product, food replacement powder, food replacement product, or animal food. In some embodiments, said food product is a pet food selected from pellet, kibble, biscuit, jerky, and rawhide.

In some embodiments, the freeze-dried mixture comprises embryonic sprouted broccoli seeds.

In some embodiments, the freeze-dried mixture comprises embryonic sprouted flax seeds and embryonic sprouted chia seeds. In some embodiments, the food product is a cereal comprising embryonic sprouted broccoli seeds.

A method of making a composition, comprises: mixing one or more embryonic sprouted plants and one or more flavorings to form a mixture, and thereafter freeze-drying the mixture.

In some embodiments, the method further comprises, before the mixing, pureeing the one or more embryonic sprouted plants.

In some embodiments, the method further comprises, before the freeze-drying, pureeing the mixture.

In some embodiments, the method further comprises, before the freeze-drying, processing the mixture with one or more steps selected from crushing the mixture, emulsifying the mixture, and masticating the mixture.

In some embodiments, the method further comprises, before the freeze-drying, the mixture is homogeneous.

In some embodiments, the method further comprises, after the freeze-drying, the freeze-dried mixture is homogeneous.

In some embodiments, the method further comprises, before the freeze-drying, molding the mixture.

In some embodiments, the method further comprises, after the freeze-drying, pulverizing the mixture into a powder.

In some embodiments, the further comprises, after the freeze-drying, unmolding the freeze-dried mixture.

In some embodiments, the method further comprises, before freeze-drying, flash freezing the mixture.

In some embodiments, the method further comprises, before freeze-drying, molding the mixture.

In one aspect, a freeze-dried, blended mixture of one or more of fruit seed sprouts and vegetable seed sprouts, forming a snack product, comprises: at least one first ingredient selected from the group comprising one or more types of sprouted fruit seeds, one or more types of sprouted vegetable seeds, and combinations thereof, wherein the at least one first ingredient is present in a proportional amount of between 50% to 98% by weight of the product prior to freeze-drying; at least one second ingredient selected from the group comprising one or more types of mature ripened fruits, one or more types of mature ripened vegetables, and combinations thereof, wherein the at least one second ingredient is present in a proportional amount in the range of between 2% to 50% by weight of the product prior to freeze-drying; and no added synthetic emulsifiers, wherein none of the ingredients of the snack product are exposed to any temperatures in excess of 140 degrees Fahrenheit.

In one embodiment, the blended mixture further comprises at least one binding sprout and at least one active ingredient sprout. In a further embodiment, the at least one binding sprout further comprises one or more of flax seed sprouts, chia seed sprouts, sunflower seed sprouts and oat sprouts. In another further embodiment, the blended mixture further comprises at least one fresh binding sprout and at least one frozen active ingredient sprout.

In another embodiment, the blended mixture further comprises at least a third ingredient including one or more prebiotic constituents.

In another embodiment, the blended mixture further comprises at least a third ingredient including one or more probiotic organisms.

In another embodiment, the blended mixture further comprises at least a third ingredient including one or more plant enzymes that aid in the process of human digestion.

In another embodiment, the blended mixture further includes one or more of polyphenols, flavonoids, terpenes and other phytochemical of interest, derived from one or more of the sprouted fruit seeds and sprouted vegetable seeds.

In another embodiment, the blended mixture further comprises sulforaphane in a proportional amount resulting in a nutritional content of at least 3 mg, 3.5 mg, 4 mg, 4.5 mg, or 5 mg of sulforaphane per serving of the snack product and up to 150 mg of sulforaphane per serving of the snack product.

In another embodiment, none of the ingredients of the snack product are exposed to any temperatures exceeding 115 degrees Fahrenheit.

In another aspect, a process for making a freeze-dried, blended mixture composed of one or more of fruit seed sprouts and vegetable seed sprouts, to form a snack product, the process steps comprises: applying a sanitary rinse to one or more types of fruit seeds and to one or more types of vegetable seeds; applying a germination soak to the one or more types of fruit seeds and to one or more types of vegetable seeds; soaking the one or more types of fruit seeds and one or more types of vegetable seeds in the germination soak for between 24 to 72 hours, transforming the one or more types of fruit and vegetable seeds into one or more types of fruit and vegetable sprouts; combining and emulsifying one or more type of fruit and vegetable sprouts with one or more mature, ripened fruits and vegetables using a blender, emulsifier or food processor to produce an emulsion; and placing the emulsion into a product form and subjecting the product form and emulsion to a freeze-drying process.

In one embodiment, the process steps further comprise freezing one or more types of the fruit and vegetable sprouts to kill the sprouts.

In another embodiment, the process steps further comprise rinsing the sprouts following the germination soak.

In another embodiment, the process steps further comprise allowing the sprouts to continue to grow following the germination soak.

In another embodiment, the process steps further comprise adding one or more of prebiotics, probiotics and naturally occurring and extracted plant enzymes to the emulsion.

In another embodiment, the combining and emulsifying process step further comprises combining and emulsifying at least one active ingredient sprout and at least one binding sprout. In a further embodiment, the combining and emulsifying at least one binding sprout comprises combining and emulsifying one or more of flax seed sprouts, chia seed sprouts, sunflower seed sprouts and oat sprouts. In another further embodiment, the combining and emulsifying at least one binding sprout comprises combining and emulsifying at least one fresh binding sprout and at least one frozen active ingredient sprout.

In one aspect, the present application comprises a freeze-dried, sprouted fruit or vegetable seed composition comprising a mixture including mature fruit or vegetable ingredients and methods of making the same.

Additional objects and advantages of the embodiments will be set forth in part in the description which follows, and in part will be obvious from the description, or may be learned by practice of the disclosed embodiments. The objects and advantages may be realized and attained by means of the elements and combinations particularly pointed out in the appended claims.

It is understood that both the foregoing general description and the following detailed description are exemplary and explanatory only, and thus not restrictive.

The accompanying drawings, which are incorporated in and constitute a part of this specification, illustrate several embodiments and together with the description, serve to explain the principles of the embodiment.

### BRIEF DESCRIPTION OF THE DRAWINGS

FIG. 1 is an embodiment of making one or more embryonic sprouted plants.

FIG. 2 is an embodiment of making a freeze-dried mixture comprising one or more embryonic sprouted plants and one or more flavorings.

FIG. 3 is an embodiment of optional processing.

FIG. 4 is an embodiment of using a composition made from the mixture.

FIG. 5 is an embodiment of molding and/or flash freezing the mixture.

### DETAILED DESCRIPTION

Traditional breakfast cereals and related snack products made from cereal flours or starches are made by extrusion. Importantly, dried, deactivated, and unsprouted plant seeds (also known as grains) are used as the base for cereal and snack products, which are then made into foamy starch-based dough via high heat extrusion.

During extrusion, the foamy dough mixture, usually made of flour, oil, sugar, and water, are placed in an extruder, where the mixture is subjected to high heat and pressure in a cylinder. As the mixture passes through the extruder, it is shaped and fully or partially cooked. Upon removing the extruded cereal from the high-pressure cylinder and returned to a normal atmosphere, the water inside the cereal turns to steam and causes the cereal to puff up, characteristic of many common breakfast cereals and related food and snack products.

Extruded cereals and snacks frequently have high calorie and fat content, yet low protein, fiber, and nutrient content. Additionally, due to the heat processing during the extrusion process, the products many contain high levels of dietary advanced glycation end products (dAGEs). dAGEs may contribute to increased oxidant stress and inflammation, which could contribute to diabetes and cardiovascular disease.

The present inventor contemplated a new class of food product, wherein the food product has the crisp texture of a cereal or snack, but neither made from a previously known foamy dough nor exposed to high heat. As explained below, the present food product makes it possible to remove additives or refined starches to make a foamy dough, as well as removing extrusion at high temperature and pressure and instead, replacing with a freeze-dried product comprising embryonic sprouted plants and flavoring. The present application also provides methodology for making a freeze-dried product comprising embryonic sprouted plants and flavoring.

Reference will now be made in detail to the present embodiments, examples of which are illustrated in the accompanying drawings. Wherever possible, the same reference numbers will be used throughout the drawings to refer to the same or like parts.

The conjunction “and” or “or” can be used in the list of members, but the “at least one of” phrase is the controlling language. For example, at least one of A, B, and C is shorthand for A alone, B alone, C alone, A and B, B and C, A and C, or A and B and C.

As explained below, in some embodiments, the present application provides a freeze-dried mixture comprising embryonic sprouted fruit and vegetable seeds (herein referred to as embryonic sprouted plants) mixed with, for example, ripened fruits and vegetables, thereby making it possible to provide a food product with an enhanced nutrient content or an improved physical stability. The composition is intended to be consumed by human being or lower animals in whole or part via the oral cavity. In some embodiments, the food is intended to be consumed by a human. In some embodiments, the food is intended to be consumed by a lower animal such as a vertebrate, including pets (like cats, dogs, etc.) or livestock (like cows, pigs, horses, goats, chickens, etc.), and may take the form of but not limited to pellet, kibble, biscuit, jerky, and rawhide. In some embodiments, the resultant product is a molded into a shape, such as a cereal shape, snack bar, dog biscuit, and the like. In other embodiments, the resultant product is not molded, but pulverized into a powder for reconstitution, for example, a powder for a food replacement drink or food supplement shake.

A. Composition

A composition comprises a freeze-dried mixture which comprises one or more embryonic sprouted plants and one or more flavorings.

In some embodiments, the composition does not comprise an additive that is a foaming agent or a food grade emulsifier. In some embodiment, the composition does not comprise an additive that is a refined starch.

1. Embryonic Sprouted Plants

To “sprout” or “sprouting” is a process by which seeds of a plant are exposed to conditions leading them to germinate and begin to sprout, or to begin to grow, as a plant grows from a seed by extending buds or shoots, characterized by rapid development and growth.

As used herein, a “sprout” develops when the embryo within the seed grows large enough and breaks out of the seed and “thus sprouts” out from underneath the soil as a small plant. The resultant small, young plant is an edible sprout, referred to herein as an Embryonic Sprouted Plant, a plurality of which is called Embryonic sprouted plants. In some embodiments, the Embryonic Sprouted Plants contain the remnants of the underlying seeds. In other embodiments, the Embryonic Sprouted Plants do not retain any portion of the underlying seeds.

As used herein, an Embryonic Sprouted Plants grows in liquid solution and for no more than 72 hours from planting the seed in solution. Thus, an Embryonic Sprouted Plants refers to a very young, sprouted plant, having higher fat and protein levels and lower water levels, which differs from the more conventional edible sprouts available for consumption. Conventional edible sprouts, such as mung bean sprouts, are generally mature sprouts, older than 72 hours, and have higher water content and reduced levels of fat and protein, compared with the instant Embryonic sprouted plants. More conventional edible sprouts have larger leaves, including fully developed cotyledons, and longer stems, characteristic of microgreens rather than the present Embryonic Sprouted Plants.

Edible Embryonic sprouted plants can be produced from many different types of plants, including but not limited to grains, legumes, beans, vegetable seeds, nuts, and edible seeds.

For example, “salad green sprouts” include alfalfa, broccoli, and clover; “gelatinous sprouts” include chia and flaxseed; “legume and bean sprouts” include green pea, lentil, and mung bean; “sprouted grains” include oats, buckwheat groats, and quinoa; and “sprouted nuts and edible seeds” may include raw almonds, hemp, or sunflower seeds.

Embryonic sprouted plants can vary in texture and flavor. For instance, some Embryonic sprouted plants are soft, crispy, or crunchy in texture. Embryonic sprouted plants flavors include spicy (radish, broccoli), sweet and delicate (green pea), mild and fresh tasting (alfalfa, clover) and clean and nutty (mung bean). Depending on the desired composition, one can select Embryonic sprouted plants having a given texture and/or flavor. For example, a baby food product may be formulated to comprise embryonic sprouted plants imparting a softer, less crunchy texture, compared to a pet food product that may be formulated to comprise edible sprouted plant seeds imparting a crunchy texture.

In some embodiments, the embryonic sprouted plants are separated from what remains of the corresponding seed from which they sprouted. In some embodiments, the embryonic sprouted plants are not separated from what remains of the corresponding seed from which they sprouted. In some embodiments, some of the embryonic sprouted plants are separated from what remains of the corresponding seed from which they sprouted.

In some embodiments, the embryonic plants seeds are sprouts of one or more or more plants. In some embodiments, the embryonic plants seeds are sprouts of one or more vegetables. In some embodiments, the embryonic plants seeds are sprouts of one or more fruits. In some embodiments, the embryonic plants seeds are sprouts of one or more fruits and one or more vegetables. In some embodiments, the embryonic plants seeds are sprouts of two or more vegetables. In some embodiments, the embryonic plants seeds are sprouts of two or more fruits. In some embodiments, the embryonic plants seeds are sprouts of two or more fruits and two or more vegetables.

In some embodiments, the one or more embryonic sprouted plants are selected from sprouts of adzuki, alfalfa, broccoli, buckwheat, cabbage, cauliflower, chia, chives, clover, dill, fenugreek, flax, garbanzo bean, garlic, kale, kidney bean, lentil bean, mung bean, mustard, navy bean, oats, peas, pinto bean, pumpkin, radish, red clover, soy bean, sunflower, wheat berry, and wheat grass. In some embodiments, the sprouts are selected from sprouts of beans, such as flax, kidney bean, lentil bean, mung bean, garbanzo bean, kidney bean, lentil bean, mung bean, and navy bean; broccoli; sunflower, such as black sunflower; chia; oats; and broccoli. In some embodiments, the one or more embryonic sprouted plants are selected from broccoli, flax, and sunflower.

The inventor knows that controlling the growth cycle of the embryonic sprouted plants makes it possible to increase the fat and protein content relative to the carbohydrate content, the latter increasing as sprouting time increases. The composition, in some embodiments, is manufactured in a way to control the growth cycle of the embryonic sprouted plants such that their starch content is controllable. In some embodiments, by controlling the growth cycle, the embryonic sprouted plants have a higher fat and protein content relative to starch content. In other embodiments, it may prove desirable to have a higher starch content.

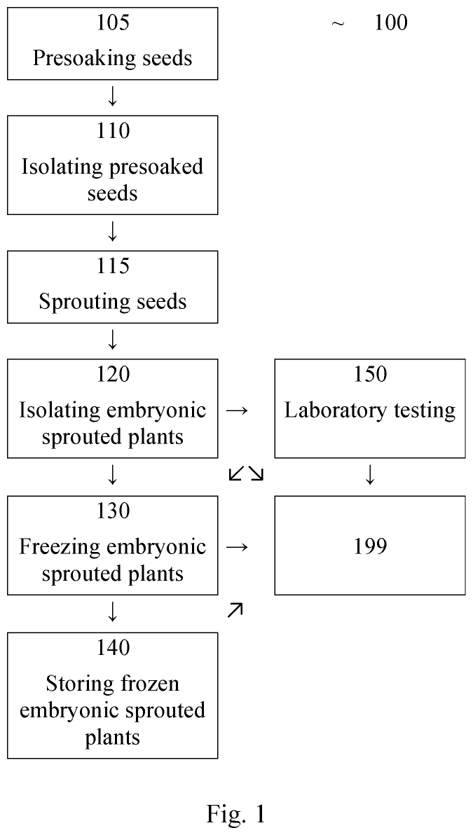

FIG. 1 shows an embodiment of making one or more embryonic sprouted plants 100, which embodiment is usable in a composition, and is discussed below.

2. Flavorings

Provided herein is a composition comprising a freeze-dried mixture which comprises one or more embryonic sprouted plants and one or more flavorings.

In some embodiments the flavorings are selected from natural and artificial flavorings.

In some embodiments, the one or more flavorings are natural.

While the present application contemplates any flavoring safe for human or animal consumption, in some embodiments, natural flavorings are selected from essential oils, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, liquid aminos, liquid smoke, picking spices, jerky seasoning, or fermentation products thereof.

In some embodiments, the one or more flavorings are selected from essential oils, oleoresins, and natural extractives (including distillates). In some embodiments, essential oils, oleoresins, and natural extractives (including distillates) are selected from alfalfa; anise almond, bitter (free from prussic acid); ambrette (seed); angelica root; angelica seed; angelica stem; angostura (cusparia bark), anise, asafetida, asafetida, asafetida, basil, bay leaves; bay (myrcia oil); bergamot (bergamot orange); bitter almond (free from prussic acid); bois de rose; cacao; camomile (chamomile) flowers, Hungarian; camomile (chamomile) flowers, roman or English; Cananga; capsicum; caraway; cardamom seed (cardamon); carob bean; carrot; cascarilla bark; cassia bark, Chinese; cassia bark, Padang or Batavia; cassia bark, Saigon; celery seed; cherry, wild bark; chervil; chicory; cinnamon bark, Ceylon; cinnamon bark, Chinese; cinnamon bark, Saigon; cinnamon leaf, Ceylon; cinnamon leaf, Chinese; cinnamon leaf, Saigon; citronella; citrus peels; clary (clary sage); clove bud; clover; coca (decocainized); coffee; cola nut; coriander; cumin (cummin); curacao orange peel (orange, bitter peel); cusparia bark; dandelion; dandelion root; dog grass (quackgrass, Triticum); elder flowers; estragole (esdragol, esdragon, tarragon); estragon (tarragon); fennel, sweet; fenugreek; galanga (galangal); geranium; geranium, east Indian; geranium, rose; ginger; grapefruit; guava; hickory bark; horehound (hoarhound); hops; horsemint; hyssop; immortelle; jasmine; juniper (berries); kola nut; laurel berries; laurel leaves; lavender; lavender, spike; lavendin; lemon; lemon balm; lemon grass; lemon peel; lime; linden flowers; locust bean; lupulin; mace; mandarin; marjoram, sweet; mate; menthol; menthyl acetate; molasses (extract); mustard; naringin; neroli, bigarade; nutmeg; onion; orange, bitter, flowers; orange, bitter, peel; orange leaf; orange, sweet; orange, sweet, flowers; orange, sweet, peel; origanum; palmarosa; paprika; parsley; pepper, black; pepper, white; peppermint; Peruvian balsam; petitgrain; petitgrain lemon; petitgrain mandarin or tangerine; pimenta; pimenta leaf; pipsissewa leaves; pomegranate; prickly ash bark; rose absolute; rose (otto of roses, attar of roses); rose buds; rose flowers; rose fruit (hips); rose geranium; rose leaves; rosemary; saffron; sage; sage, Greek; sage, Spanish; St. John's bread; savory, summer; savory, winter; Schinus molle; sloe berries (blackthorn berries); spearmint; spike lavender; tamarind; tangerine; tarragon; tea; thyme; thyme, white; thyme, wild or creeping; Triticum (see dog grass); tuberose; turmeric; vanilla; violet flowers; violet leaves; violet leaved absolute; wild cherry bark; ylang-ylang; and zedoary bark. In some embodiments, the one or more flavorings are selected from citrus essential oils, vanilla, and stevia leaf.

In some embodiments, the one or more flavorings are selected from one or more fruits or one or more vegetables. In some embodiments, the one or more flavorings are selected from one or more fruits. In some embodiments, the one or more flavorings are selected from one or more vegetables. In some embodiments, the one or more flavorings are selected from one or more fruits and one or more vegetables. In some embodiments, but in no way limiting, the one or more ripened fruits or vegetables are selected from acai, alma, apples, avocados, bananas, bean pods, blackberries, blueberries, cantaloupe, cherries, choke berries, clementine, corn kernels, dates, figs, goji berries, grapes, lemons, limes, mango, miracle berry (Synsepalum dulcificum), nectarines, oranges, peaches, pears, pineapple, plums, raspberries, strawberries, and watermelon. In some embodiments, the one or more ripened fruits or vegetables are selected from asparagus, bell peppers, broccoli, cabbage, carrots, cauliflower, celery, corn, cucumbers, garlic, green beans, green onions, lettuce, mushrooms, onions, potatoes, spinach, sweet potatoes, tomatoes, and wheat grains. In some embodiments, the one or more fruits or one or more vegetables are selected from banana, blueberry, and dates.

“Fruit” or “fruits” in the botanical sense refers to the seed-bearing structure in flowering plants (also known as angiosperms) formed from the ovary after flowering, including common fruits such as apples, bananas, grapes, oranges, melons, dates, coconuts, and berries, such as strawberries, but also less common fruits such as bean pods, corn kernels, tomatoes, and wheat grains. However, and as used herein, “fruit” includes any plant or part thereof safe for human or animal consumption.

“Vegetable” or “vegetables” in the botanical sense means any plant part consumed for food that is not a fruit or seed. However, and as used herein, vegetable may refer to any edible stems, stalks, roots, tubers, bulbs, leaves, flowers, some fruits, pulses, fungi, algae, and the like. Exemplary vegetables include but are not limited to carrot, potato, pepper, radish, lettuce, cauliflower, peas, beans, mushroom, truffle, Spirulina, moringa, and seaweed.

In some embodiments, the one or more flavorings are selected from one or more spices. In some embodiments, the spices are selected from allspice (Pimenta dioica), angelica (Angelica archangelica), anise (Pimpinella anisum), asafoetida (Ferula assa-foetida), bay leaf (Laurus nobilis), basil (Ocimum basilicum), bergamot (Monarda species), black cumin (Nigella sativa), black mustard (Brassica nigra), black pepper (Piper nigrum), borage (Borago officinalis), brown mustard (Brassica juncea), burnet (Sanguisorba minor and S. officinalis), caraway (Carum carvi), cardamom (Elettaria cardamomum), cassia (Cinnamomum cassia), catnip (Nepeta cataria), cayenne pepper (Capsicum annuum), celery seed (Apium graveolens, variety dulce), chervil (Anthriscus cerefolium), chicory (Cichorium intybus), chili pepper (Capsicum species), chives (Allium schoenoprasum), cicely (Myrrhis odorata), cilantro (Coriandrum sativum), cinnamon (Cinnamomum verum), clove (Syzygium aromaticum), coriander (Coriandrum sativum), costmary (Tanacetum balsamita), cumin (Cuminum cyminum), curry, dill (Anethum graveolens), fennel (Foeniculum vulgare), fenugreek (Trigonella foenum-graecum), file (Sassafras albidum), ginger (Zingiber officinale), grains of paradise (Aframomum melegueta), holy basil (Ocimum tenuiflorum), horehound (Marrubium vulgare), horseradish (Armoracia rusticana), hyssop (Hyssopus officinalis), lavender (Lavandula species), lemon balm (Melissa officinalis), lemon grass (Cymbopogon citratus), lemon verbena (Aloysia citrodora), licorice (Glycyrrhiza glabra), lovage (Levisticum officinale), mace (Myristica fragrans), marjoram (Origanum majorana), nutmeg (Myristica fragrans), oregano (Origanum vulgare), paprika (Capsicum annuum), parsley (Petroselinum crispum), peppermint (Mentha xpiperita), poppy seed (Papaver somniferum), rosemary (Salvia rosmarinus), rue (Ruta graveolens), saffron (Crocus sativus), sage (Salvia officinalis), savory (Satureja hortensis and S. montana), salt, sesame (Sesamum indicum), sorrel (Rumex species), star anise (Illicium verum), spearmint (Mentha spicata), tarragon (Artemisia dracunculus), thyme (Thymus vulgaris), turmeric (Curcuma longa), vanilla (Vanilla planifolia and V. tahitensis), wasabi (Eutrema japonicum), and white mustard (Sinapis alba). In some embodiments, the spices are selected from saffron, garlic, onion, mustard seed, and sea salt. In some embodiments, the spices are selected from turmeric, spirulina, and nutritional yeast.

In some embodiments, the one or more flavorings are selected from artificial flavorings. In some embodiments the artificial flavorings are selected from any substance, the function of which is to impart flavor, which is not derived from a spice, fruit or fruit juice, vegetable or vegetable juice, edible yeast, herb, bark, bud, root, leaf or similar plant material, meat, fish, poultry, eggs, dairy products, or fermentation products thereof. The present application contemplates any flavoring safe for human or animal consumption.

3. Freeze-Drying

The present application provides a composition comprising a freeze-dried mixture which comprises one or more embryonic sprouted plants and one or more flavorings.

“Freeze-dry” is a dehydration process that works by freezing the material and then reducing the surrounding pressure to allow the frozen water in the material to sublimate directly from the solid phase to gas. Additional steps are possible to remove any unfrozen water.

In some embodiments, the freeze-dried mixture is homogenous.

In some embodiments, the composition, including the mixture, is freeze-dried.

In some embodiments, the entire composition is freeze-dried. In some embodiments, less than all ingredients of the composition are freeze-dried. In some embodiments, only the mixture is freeze-dried.

In some embodiments, the composition and or the freeze-dried mixture is molded by freeze-drying into a desired shape. In some embodiments, the shape is selected from disc, cylindrical, cubic, rectangular, and spherical. In some embodiments, the shape is modeled after animals (zoo animals, dinosaurs, etc.), plants (flowers, trees, etc.), and characters appealable for children (like cartoon characters, etc.) or pets (a dog bone, a mouse, a biscuit, a pellet, or a disc).

In some embodiments, the composition and or the freeze-dried mixture is not molded, but rather pulverized into a powder. Such powder may be reconstituted or resuspended for use in a food replacement product, such as a food replacement shake, or a food supplement product.

In some embodiments, the composition and/or the freeze-dried mixture comprises one or more optional ingredients. In some embodiments, the composition or the freeze-dried mixture further comprises one or more optional ingredients selected from prebiotics, probiotics, flavorings, coatings, natural minerals, vitamins, and any other ingredient that may alter the taste qualities of a food product.

In some embodiments, the composition or the freeze-dried mixture further comprises one or more optional ingredients selected from prebiotics. “Prebiotics” are nondigestible food ingredients that promote the growth of beneficial microorganisms in and on a host when administered to the host body.

In some embodiments, prebiotics are selected from oligosaccharides.

In some embodiments, the composition or the freeze-dried mixture further comprises one or more optional ingredients selected from probiotics. “Probiotics” are live microorganisms which confer a health benefit on the host when administered to the host body. Probiotic foods include, without limitation, lactic acid bacteria fermented dairy products, such as yogurt, kefir and buttermilk, and other fermented and probiotic-fortified foods, such as pickled vegetables, kimchi, pao cai, and sauerkraut, soy products such as tempeh, miso, and soy sauce.

In some embodiments, the probiotics are selected from lactic acid bacteria (LAB) probiotics. In some embodiments, LAB probiotics include the following core genera: Lactobacillus, Lactococcus, Leuconostoc, Pediococcus, and Streptococcus, as well as the more peripheral Aerococcus, Carnobacterium, Enterococcus, Oenococcus, Sporolactobacillus, Tetragenococcus, Vagococcus, and Weissella, which belong to the order Lactobacillales, and other probiotic bacteria including, without limitation, Acetobacter pasteurianus, A. aceti, Bifidobacterium bifidum, Gluconacetobacter xylinus, Gluconobacter oxydan, Lactococcus lactis, Leuconostoc argentinum, L. citreum, L. fallax, L. mesenteroides, Lactobacillus acidophilus, L. brevis, L. casei, L. coryniformis, Lactobacillus delbrueckii subsp. bulgaricus, L. fallax, L. fermentum, L. helveticus, L. kefiranofaciens, L. kimchi, L. lactis, L. paraplantarum, L. plantarum, L. pentosus, Pediococcus pentosaceus, Streptococcus thermophilus, S. lactis Weissella confusa, W. koreenis, W. cibaria, and Zygosaccharomyces sp.

In some embodiments, the probiotics are selected from members of the Leuconostocaceae family. The Leuconostocaceae family belongs to the order of Lactobacillales that are commonly called lactic acid bacteria (LAB) like the Lactobacillaceae family. Their main trait is the production, exclusively or not, of lactic acid from carbohydrate fermentation. In the past, they formed the Leuconostoc genus, which was roughly defined as heterofermentative cocci. To date, this family comprises four genera: Fructobacillus, Leuconostoc, Oenococcus, and Weissella.

In some embodiments, the probiotics are selected from Gram-positive nonsporulating bacteria. In some embodiments, all members of this family are Gram-positive, nonsporulating bacteria, exhibiting G+C DNA content less than 50%. They develop in anaerobic or aerobic conditions, and a catalase generally is not present. They are usually mesophiles, cultured at temperatures around 30° C. The optimal pH range for their multiplication is variable according to the genera, species, and even strain, but mostly it is pH 6 or above. Like the other groups of LAB, they need complex media for growth because of their need for amino acids, peptides, carbohydrates, vitamins, and metallic ions.

In some embodiments, the composition or the freeze-dried mixture further comprises one or more additional flavorings. The flavorings are noted above.

In some embodiments, the composition or the freeze-dried mixture further comprises one or more optional ingredients selected from coatings. In some embodiments, the coatings are selected from sugars, salts, fruits, and vegetables. In some embodiments, the fruit is a miracle berry.

In some embodiments, a coating may comprise freeze-dried embryonic sprouted plants. For example, a fruit or vegetable slice may be coated in freeze-dried embryonic sprouted plants, optionally with one or more additional flavoring or coatings.

In some embodiments, the composition or the freeze-dried mixture further comprises one or more optional ingredients selected from natural minerals. In some embodiments, the natural minerals are selected from minerals from plants. In some embodiments, the minerals are selected from calcium, chloride, Magnesium, Potassium, and Sodium from plants. In some embodiments, the Calcium is available from leafy green vegetables; Chloride is available from salt; Magnesium is available from Spinach, broccoli, legumes, seeds, and whole-wheat bread; Potassium is available from some fruits, some vegetables, grains, and legumes; and Sodium is available from salt, soy sauce, and some vegetables. In some embodiments, the minerals are selected from chromium, copper, fluoride, iodine, iron, manganese, selenium and zinc. In some embodiments, the chromium is available from nuts; copper is available from nuts, seeds, some whole-grains, beans, or prunes; fluoride is available from teas; iodine is available from salt; iron is available from some fruits and green vegetables; and manganese is available from nuts, legumes, and teas; selenium is available from walnuts; and zinc is available from legumes and some whole grains.

In some embodiments, the composition or the freeze-dried mixture further comprises one or more optional ingredients selected from vitamins. In some embodiments, the vitamins are selected from vitamins from plants. In some embodiments, the vitamins are selected from water soluble vitamins. In some embodiments, the water-soluble vitamins are selected from B-1, B-2, B-3, B-5, B-6, B-7, B-9, B-12, vitamin C. In some embodiments, B-1 is available from watermelon and acorn squash; B-2 is available from grains and cereals; B-3 is available from whole grains, mushrooms, and potatoes; B-5 is available from broccoli, avocados, and mushrooms; B-6 is available from legumes, tofu and bananas; B-7 is available from whole grains and soybeans; B-9 is available from grains, asparagus, spinach, broccoli, legumes (such as black-eyed peas and chickpeas), and orange juice; B-12 is available from cereals; and Vitamin C is available from Citrus fruits, potatoes, broccoli, bell peppers, spinach, strawberries, tomatoes, and Brussels sprouts. In some embodiments, the vitamins are selected from fat soluble vitamins. In some embodiments, the fat-soluble vitamins are selected from A, D, E, and K. In some embodiments, Vitamin A is available from sweet potatoes, carrots, pumpkins, spinach, and mangoes; Vitamin D is available from cereals; Vitamin E is available from vegetables oils, leafy green vegetables, whole grains, and nuts; and Vitamin K is available from spinach, broccoli, and kale.

In some embodiments, the composition or the freeze-dried mixture further comprises one or more optional ingredients selected from any other ingredient that may alter the taste qualities of a food product. In some embodiments, the any other ingredient is selected to maintain or improve safety and freshness. In some embodiments, the any other ingredient is selected from antioxidants. In some embodiments, the any other ingredient is selected from Ascorbic acid, citric acid, sodium benzoate, calcium propionate, sodium erythorbate, sodium nitrite, calcium sorbate, potassium sorbate, BHA, BHT, and EDTA.

In some embodiments, the one or more optional ingredients are selected from sweeteners. In some embodiments, sweeteners are selected from Sucrose (sugar), glucose, fructose, sorbitol, mannitol, corn syrup, high fructose corn syrup, saccharin, aspartame, sucralose, acesulfame potassium (acesulfame-K), and neotame.

In some embodiments, the one or more optional ingredients are selected from color additives. In some embodiments, the color additives are selected from FD&C Blue Nos. 1 and 2, FD&C Green No. 3, FD&C Red Nos. 3 and 40, FD&C Yellow Nos. 5 and 6, Orange B, Citrus Red No. 2, annatto extract, beta-carotene, grape skin extract, cochineal extract or carmine, paprika oleoresin, caramel color, fruit and vegetable juices, and saffron. In some embodiments, the natural color additives are selected from annatto extract (yellow), dehydrated beets (bluish-red to brown), caramel (yellow to tan), beta-carotene (yellow to orange) and grape skin extract (red, green).

4. Food Products

In some embodiments, the composition is a food. In some embodiments, the food has a form selected from cereal, crackers, snack products, chips, cookies, snack bars or disks, baby food, food replacement shake, food replacement powder, pet food, non-human animal feed, and the like.

The inventor also knows that extrusion may increase a food's starch content. The food, in some embodiments, is manufactured in a way to avoid extrusion and thus increasing starch contents. The food, in some embodiments, is manufactured in a way to avoid using flour and thus increasing starch contents.

The inventor knows that adding too much heat during manufacturing alters the nutrition profile of the resultant food. The food, in some embodiments, is manufactured in a way to control the heat added.

In one embodiment, the present application comprises an embryonic sprouted plants useful in the preparation of an edible freeze-dried sprouted fruit and/or vegetable product. The first component of the composition comprises an embryonic sprouted plants, such as a fruit and/or vegetable plant ingredient. The embryonic sprouted fruit and/or vegetable plant ingredient may be selected from any ingredients ordinarily known in the art or even those that are not preferentially used.

In some embodiments, the mixture comprises one or more flavorings selected from one or more fruits; or two or more fruits; or one or more vegetables; or two or more vegetables; or one or more fruits and one or more vegetables; or two or more fruits and two or more vegetables.

In some embodiments, the mixture comprises two or more embryonic plant seeds selected from two or more fruits; or two or more vegetables; or one or more vegetables and one or more fruits; or two or more fruits and two or more vegetables.

In some embodiments, the composition and/or freeze-dried mixture does not have any preservatives or additives.

In some embodiments, the composition and/or freeze-dried mixture has a sulforaphane content ranging from 1 mg to 175 mg per cup; or from 5 mg to 150 mg per cup; or from 20 mg to 125 mg per cup.

B. Methodology

A method of making a composition, comprises mixing one or more embryonic sprouted plants and one or more flavorings to form a mixture, and thereafter freeze-drying the mixture.

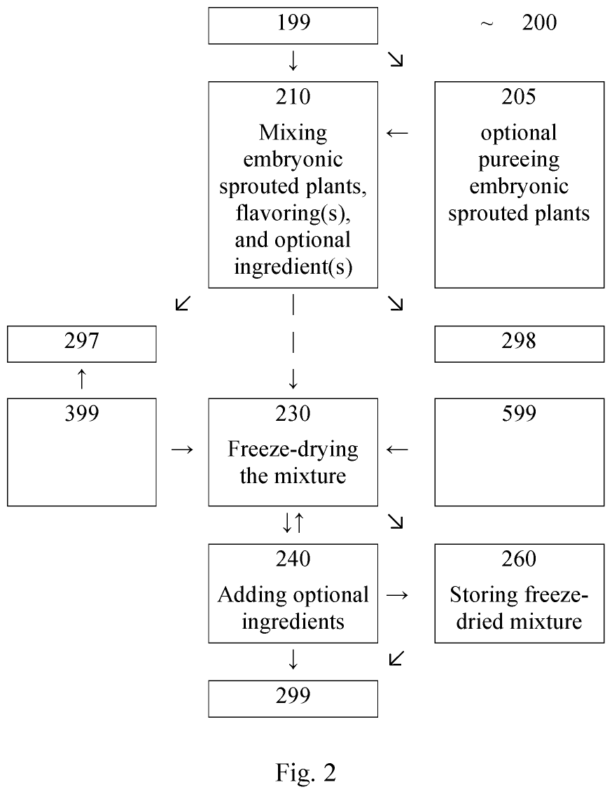

FIG. 2 is embodiment 200 of making a freeze-dried mixture comprising one or more embryonic sprouted plants, one or more flavorings and one or more optional ingredients. In embodiment 200, one or more embryonic sprouted plants, one or more flavorings and one or more optional ingredients are mixed 210.

In some embodiments, embryonic sprouted plants are selected depending on the desired texture for the end product. For denser desired textures, a lesser mass binding sprouts are used and more active ingredient sprouts, such as, sprouts containing the desired polyphenols and other phytochemicals of interest, are used. Conversely, for lighter, more airy end product textures, greater proportions of the binding sprouts are used, and lesser amounts of the active ingredient sprouts. For example, a baby food product may be formulated to comprise embryonic sprouted plants imparting a softer, less crunchy texture, compared to a pet food product that may be formulated to comprise edible sprouted plant seeds imparting a crunchy texture.

After the seeds are selected, the seeds are typically rinsed as a sanitary step (not shown).

In some embodiments, the one or more embryonic sprouted plants are made by FIG. 1's embodiment 100.

In FIG. 1, the seeds are optionally presoaked to initiate germination 105 and isolated for sprouting 110.

Some types of seeds are processed with a presoak 105 followed by a rinse, some seeds are simply processed with only a presoak 105 (e.g., the binding sprouts including, without limitation, grains such as flax, chia, sunflower and oat, as well as other grains), while some kinds of seeds are allowed to grow for a period of time following a presoak 105 (i.e., the sprouts are removed from the soak and allowed to continue germinating and growing; e.g., active ingredient sprouts such as broccoli, cauliflower, cabbages, kale, etc.).

The binding sprouts, i.e., grains including flax, chia, sunflower and oat, as well as other grains, may all be presoaked for a duration of time ranging from 12 hours to 48 hours, with 24 hours being optimal for the enhanced binding properties of these sprouts. If less binding properties are desired, a longer presoak, up to 48 hours, may be applied.

In some embodiments, all types of seeds are allowed to soak for a set, optimal period of time optimal to initiate and sustain the germination process for the specific type of seed. For instance, flax seeds soak for 48 hours, broccoli seeds soak for 72 hours, and sunflowers soak for 24 hours. The duration of time selected as optimal for a particular type of sprout depends on the maximal production of polyphenols and other phytochemicals of interest. For instance, sulforaphane contained in broccoli sprouts peaks on day three (3), or at 72 hours.

After presoaking 105, the presoaked seeds are isolated for sprouting 110.

The isolated seeds may be sprouted 115 using any conventional means including, without limitation, sprouting machines.

Seeds of the selected types of fruit and/or vegetable seeds are sprouted and allowed to grow for an optimal duration of time. In some embodiments, the time ranges from between 24 to 72 hours or from 36 to 52 hours. These time ranges include, if any, the presoaking 115, when the seed comes in contact with water and germination begins. In some embodiments, the germinated seeds are not exposed to above ambient room temperatures sufficient to deactivate germination.

In some embodiments, the embryonic sprouted plants are isolated 120.

In some embodiments, the isolated embryonic sprouted plants are subjected to freezing 130, e.g., by placing the isolated embryonic sprouted plants into a freezer. Freezing the sprouts provides several advantages, including convenient storage and reduction of the overwhelming, pungent flavors characteristic of some fresh sprouts. In some embodiments, freezing the embryonic sprouted plants provides several advantages, including that it is convenient to store the sprouts in frozen form and also that freezing mitigates the effects of some of the more pungent, aromatic compounds characteristic of fresh sprouts rich in the polyphenols and other phytochemicals of interest.

In some embodiments, the frozen embryonic sprouted plants are stored 140. In some embodiments, the storage is from 6 to 24 hours or from 1 to 7 days or from about 15 to 200 days.

In some embodiments, the isolated embryonic sprouted plants are laboratory tested 150 to ensure they are safe for consumption via to oral cavity of the intended eater. For example, testing for pathogens and contaminants (e.g., Salmonella, E. coli, and other harmful microbes and bacteria, as well as environmental contaminants), in accordance with FDA GMP and HACCP Plan requirements, occurs at different points throughout the process. For instance, the various seeds are tested by the respective growers/vendors for contaminants pre-shipping. The germination soak water may be tested continuously or periodically at appropriate intervals during the germination soak. The sprouts may further be tested post-germination, before they are placed into the freezer.

After step 150, the tested embryonic sprouted plants are usable in steps 130 or 140.

After a round of sprouting, the sprouting machine should be sanitized, e.g., using ozonated water, apple cider vinegar, or other sanitation agent or solution, before starting another batch of sprouts. The temperature of the sprouting soak water ranges from 68° F. to 70° F.

The embryonic sprouted plants from steps 120, 130, 140, or 150 are useable 199 in embodiment 200.

In some embodiments, the one or more embryonic sprouted plants are maintained at a temperature below 140° F. or below 125° F. or below 115° F. or below 105° F.

In some embodiments, the embryonic sprouted plants are pureed 205. In some embodiments, before the mixing, the one or more embryonic sprouted plants are pureed. In some embodiments, before the freeze-drying, the mixture is pureed (not shown).

Following step 120, 130, 140, or 150, in some embodiments the sprouts are pureed. In some embodiments, some proportion of fresh sprouts (typically the binding sprouts) may be added to the puree. It is possible to add some proportion of fresh binding sprouts to the puree, as these fresh sprouts contain binding and thickening compounds (e.g., fruit pectins) that are mucogenic and produce a gelatinous texture, making it easier to whip air into a pureed product containing the fresh binding sprouts.

Due to the presence of these compounds in these fresh sprouts, no added emulsifying agents (e.g., binders and thickeners) are needed. Creating a puree using solely the frozen sprouts may still result in emulsification of the puree. But, including the fresh binding sprouts makes the emulsion/emulsification much more robust.

In various embodiments, the pureed end product may include only fresh sprouts, only frozen sprouts, or a mixture of fresh and frozen sprouts.

In some embodiments, the result of 205 is usable for mixing 210.

In some embodiments, pureeing 205 is at a temperature below 140° F. or below 125° F. or below 115° F. or below 105° F.

In some embodiments, the result of 120, 130, 140, or 150 is usable for mixing 210.

In some embodiments, the mixing 210 uses stirring or folding of the mixture.

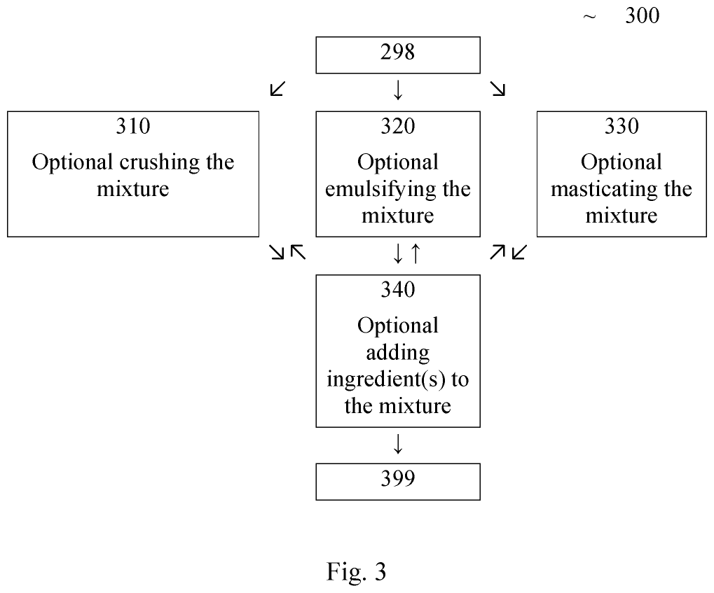

In some embodiments, the mixing 210 includes mixing one or more optional ingredients 298, per FIG. 3's step 340.

In some embodiments, mixing 210 is at a temperature below 140° F. or below 125° F. or below 115° F. or below 105° F.

In some embodiments, the method further comprises, before the freeze-drying, processing the mixture with one or more steps selected from crushing the mixture, emulsifying the mixture, and masticating the mixture 298, FIG. 3.

In some embodiments, the method further comprises, before the freeze-drying, crushing the mixture 298, 310. In some embodiments, all ingredients for the recipe are combined and processed through a crushing machine.

Formulated mixtures include mature and/or embryonic (i.e., germinated sprouting) plants and the natural properties of sprouts optimize the nutritional value of the product and also help to maintain product shape. Blending tools used may include one or more of a crushing machine, an emulsifying tool, commercial food processor and a blender.

Following the crushing machine, in some embodiments, once the ingredients have been thoroughly combined to create a totally homogenous mixture, typically a gelatinous doughy material, probiotics or plant enzymes (e.g., plant derived enzymes that aid in human digestion—those occurring naturally within the sprouts and also extracted plant enzymes) may be added to improve the nutritional content and health benefits of the end product.

In some embodiments, the method further comprises, before the freeze-drying, emulsifying the mixture 298, 320. In some embodiments, emulsifying is performed with a blender, crusher, or food processor.

In some embodiments, the method further comprises, before the freeze-drying, masticating the mixture 298, 330. In some embodiments, mastication is performed with a grinder, such as a mill, e.g., a hammer, ball, roller, or disc mill.

In some embodiments, the method further comprises, before the freeze-drying, adding other ingredients 298, 340. In some embodiments, the one or more ingredients selected from prebiotics, probiotics, flavorings, coatings, natural minerals, vitamins, and any other ingredient as noted herein above.

In some embodiments, each of steps under 298, i.e., steps 310, 320, 330, and 340, is at a temperature below 140° F. or below 125° F. or below 115° F. or below 105° F.

In some embodiments, before the freeze-drying, the mixture is homogeneous. In some embodiments, before the freeze-drying, the mixture is inhomogeneous.

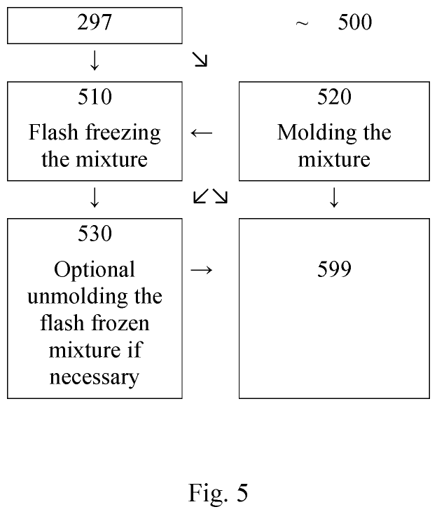

The result of step 399 (i.e., step 310, 320, 330, or 340) is usable in embodiment 200 of FIG. 2, e.g., in one or more other processing steps, e.g., 297 of FIG. 5.

In some embodiments, the method further comprises, before the freeze-drying, other processing 297, such as, in FIG. 5, flash freezing 510.

In some embodiments, other processing 297 includes flash freezing the mixture 510. Flash freezing, in some embodiments, includes placing the mixture into a flash freezer, e.g., having a chamber temperature ranging from −346° F. to 10° F.; or from −320° F. to 5° F.; or from −100° F. to 0° F.; or from −50° F. to −5° F. In some embodiments the flash freezer is a fluidized bed freezer, which blows cold air streams with such a force that the individual food pieces float on the airstream while freezing. In some embodiments the flash freezer is a multi-station plate freezer configured to hold shelves in a cabinet which is cooled to a temperature sufficient to freeze the mixture. In some embodiments the flash freezer is an air-blast freeze tunnel, which, e.g., has trays on which the mixture rides as the trays are pushed through the tunnel cooled to a temperature sufficient to freeze the mixture.

In some embodiments, other processing 297 includes molding the mixture 520 and thereafter unmolding the mixture 530. In some embodiments, the molding 520 and/or unmolding 530 is/are conducted at an environmental temperature below 50° F. or 40° F. or 30° F.

In some embodiments, the molded mixture (e.g., the result of step 520) is flash frozen 510, as just noted. In some embodiments, the mixture is in the mold during flash freezing 510. After flash freezing, the molded, flash-frozen mixture is unmolded 530.

In some embodiments, the result of step 510, 520, or 530 is usable for freeze-drying 230. In some embodiments, the result of step 210 is useable in freeze-drying 230.

The mixture from 210, 399, or 599 is freeze-dried 230. In some embodiments, the freeze-drying is at a lower pressure (e.g., few millibars to a few 10s of millibars) and lower temperature (below 32° F., or below −15° F., or below −35° F.) to perform sublimination water from the mixture. In some embodiments, multiply drying stages occurs to remove any unfrozen water. In some embodiments, the resultant freeze-dried mixture has a water content ranging from less than 1 to 8% by weight or from 1 to 4% by weight or less than 7% by weight or less than 3% by weight of the water in the non-freeze-dried mixture.

For example, the mixture is tested for moisture content and/or micronutrient content, placed into trays and molds, and then put into the freezer, typically for 12-24 hours. After the mixture is frozen it is then placed into the freeze-dryer and run through the freeze-drying process. In some embodiments, the molds are loaded onto trolley carts, which may be automated to enter and exit the freeze-dryer vacuum chamber at specific times or to leave after a specified duration. Freeze-dryers may operate on radiant or conductive cooling.

In some embodiments, the freeze-drying process may be automated to ramp or increase and/or decrease at specific rates, over specific periods of time. In certain other embodiments, the freeze-drying process may be incorporate a blast freezer controlled to deliver a flash freeze treatment, which is advantageous for production of smaller crystalline structures. The lower the temperature provided, the quicker the flash freeze and the smaller the ice crystals.

In some embodiments, the method further comprising adding one or more ingredients to the freeze-dried mixture 240. In some embodiments, the one or more ingredients selected from prebiotics, probiotics, flavorings, coatings, natural minerals, vitamins, and any other ingredient as noted herein above. In some embodiments, the result of step 240 is subjected to another round of freeze-drying 230 or stored 260.

In some embodiments, the freeze-dried mixture from step 230 or composition from 240 is powdered, e.g., by pulverizing or crushing to form a powder. (Not shown). In some embodiments, the powder is stored 260.

In some embodiments, the composition comprising the freeze-dried mixture is stored 260.

In some embodiments, after the freeze-drying, the composition comprising the freeze-dried mixture is homogeneous. In some embodiments, after the freeze-drying, the composition comprising the freeze-dried mixture is inhomogeneous.

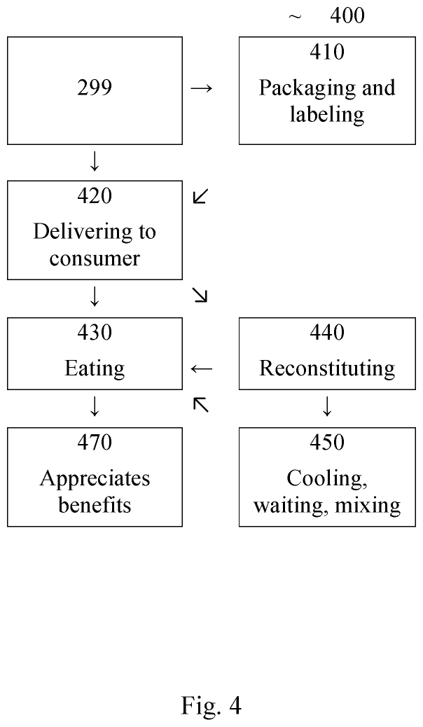

The composition from step 230, 240, 250, or 260 is usable 299, e.g., as shown in FIG. 4.

In FIG. 4, the composition is optionally packaged and labeled 410 before delivered to consumers 420 or just delivered to consumers 420.

In some embodiments, the molded freeze-dried products are tested for moisture and/or micronutrient content. Once quality is assured, the product is packaged and shipped.

The composition is intended to be eaten by a consumer 430. In some embodiments, the composition is consumed by human being or lower animals in whole or part via the oral cavity. In some embodiments, the food is intended to be consumed by a human. In some embodiments, the food is intended to be consumed by a lower animal such as a vertebrate, including pets (like cats, dogs, etc.) or livestock (like cows, pigs, horses, goats, chickens, etc.).

In some embodiments, the composition is reconstituted 440 before being eaten 430. For example, reconstituting includes adding, to the composition, a liquid, such as water or milk. In some embodiments, reconstituting is facilitated by stirring.

In some embodiments, reconstituting is followed by additional steps 450, including cooling the composition, waiting a period of time such as 15 minutes to 12 hours while cooling, and thereafter mixing the reconstituted composition, e.g., by stirring or shaking. Afterwards, the reconstituted composition is eaten 430.

In some embodiments, the consumer appreciates benefits 470. For example, in some embodiments, the consumer (or the consumer's parent, guardian, owner, farmer, care-giver, etc.) appreciates less starch present in the composition.

In some embodiments of FIGS. 1, 2, 3, and/or 5 at no point during the method is the composition or mixture or any of its ingredients processed at temperatures exceeding 140° F. or 125° F. or 115° F. or 105° F. In some embodiments of FIG. 2, at no point during the method is the composition or mixture or any of its ingredients processed at temperatures exceeding 140° F. or 125° F. or 115° F. or 105° F. By keeping the food processing temperatures at below the stated temperatures enables the mixture and ultimate composition to retain the benefits of bioactive raw plant enzymes. Using embryonic raw plants, or sprouts, produces the greatest concentration of the plant enzymes, polyphenols, and other phytochemicals of interest. However, processing at the stated slightly elevated temperatures (e.g., temperatures below 140° F.) enables the preservation of the molecular integrity of the various described nutrients while producing a “cooked-like” or “thermally-processed” snack product. In some embodiments, the consumer (or the consumer's parent, owner, farmer, care-giver, etc.) appreciates or is made to appreciate the lower temperatures or less heat used to make the composition.

In some embodiments of FIGS. 1, 2, 3, and/or 5 at no point during the method is the composition or mixture or any of its ingredients processed using extrusion.

In some embodiments, broccoli sprouts (e.g., a patented variety containing high concentrations of the polyphenol sulforaphane) are included in the pureed, freeze-dried end product at proportional ranges from 100 percent (100%) to five percent (5%) by weight. For instance, depending on the product application (e.g., autism, cancer, etc.), the broccoli sprouts may be included at a proportion designed to yield 5 mg sulforaphane per serving (maintenance for normal, healthy consumers), 15 mg sulforaphane per serving (e.g., autism), or 150 mg sulforaphane (cancer, DNA repair, etc.). In this way, the end product snack may easily be tailored to or optimized for specific diseases and functional performance.

In some embodiments, at step 210, the one or more embryonic sprouted plants are present in an amount ranging from 2% to 98%, or from 10% to 90%, or from 20% to 80% by weight relative to the total weight of the one or more embryonic sprouted plants plus the one or more flavorings selected from fruits and vegetables. Such embodiments tend to be crunchy.

In some embodiments, at step 210, the one or more embryonic sprouted plants are present in an amount ranging from 50% to 98%, or from 60% to 90%, or from 70% to 80% by weight relative to the total weight of the one or more embryonic sprouted plants plus the one or more flavorings selected from fruits and vegetables. Such embodiments tend to be crunchy.

In some embodiments, at step 210, the one or more embryonic sprouted plants are present in an amount ranging from 2% to 40%, or from 10% to 30%, or from 15% to 25% by weight relative to the total weight of the one or more embryonic sprouted plants plus the one or more flavorings selected from fruits and vegetables. Such embodiments tend to be savory.

Further, the present invention provides a method of providing sprouted fruit and vegetable seeds through the compositions disclosed herein. It should be understood that the main ingredient in the compositions can be from the group comprising fruit, vegetables, grains, proteins, dairy substitutes and any combinations thereof.

The following Examples are illustrative and do not limit the disclosure.

### Example 1: Methodology for Making Freeze-Dried Embryonic Sprouted Food Product

A method of preparing a freeze-dried, embryonic sprouted fruit and/or vegetable product comprising the steps of (a) providing a blend or mixture including one or more of sprouted fruit seeds and sprouted vegetable seeds, (b) adding to the blend a puree of one or more of a ripened fruit and a ripened vegetable, (c) adding fresh sprouts, (d) adding probiotics to or fermenting the blend or mixture, and (e) cooling the product to freezing temperatures; and (f) freeze-drying the product.

Procedure:
1. Sanitary rinse of the selected fruit and/or vegetable seeds.
2. Sprout the fruit and/or vegetable seeds for the desired germination period using at least a germination soak.
3. Following germination, the sprouts may be subjected to a freezing-kill step, with some sprouts being optionally rinsed and/or allowed to grow for an additional period of time to the freeze-kill step.
4. Combine and emulsify embryonic and mature plants using a mixing tool, such as an emulsifier, commercial food processor or a blender. A crushing machine may additionally be used to masticate the sprouts.
5. Optionally add one or more of prebiotics, probiotics and plant enzymes (e.g., naturally occurring and/or extracted plant enzymes).
6. Many speed variations may be applied, ramping between low-speed and high-speed and vice versa, and after processing the puree, the emulsifying tool is shut down.
7. Then the product is molded and formed and frozen.
8. Next, the frozen product forms are subject to freeze-drying.
9. Last, the product is packaged and shipped.

### Example 2: Freeze-Dried Embryonic Sprouted Plants Food Product

The present application provides a freeze-dried embryonic sprouted plants-based cereal product that is formulated for optimal nutrition and processed to maintain nutrient integrity.

Exemplary freeze-dried embryonic sprouted plant cereal products include embryonic sprouted plants and any combination of fruits, vegetables, and flavorings.

As shown below in Table 1, freeze-dried embryonic sprouted plants-based products may have sulforaphane, which may confer health promoting properties, including antioxidant, anti-inflammatory, anticancer, antimicrobial, anti-aging, neuroprotective, and antidiabetic properties.

TABLE 1
Freeze-dried embryonic sprouted cereal products have Sulforaphane

| | | | | Sulforaphane | |
|---|---|---|---|---|---|
| | | | | Content | |
| Cereal | Embryonic | Fruits and/or | | [per l cup | |
| Type | sprouted plants | Vegetables | Flavorings | serving] | |
| Banana | Sprouted | Banana | Vanilla, | 3.65 | mg |
| Bread | Sunflower | Dates | Stevia | | |
| | Seeds | | | | |
| | Sprouted Flax | | | | |
| | Seeds | | | | |
| | Sprouted | | | | |
| | Broccoli | | | | |
| | Seeds | | | | |
| Fruit | Sprouted Flax | Dates | Lemon | 4.0 | mg |
| Fantasy | Seeds | Spirulina | Essential | | |
| | Sprouted | Turmeric | Oil | | |
| | Broccoli | | Orange | | |
| | Seeds | | Essential Oil | | |
| | | | Lime | | |
| | | | Essential | | |
| | | | Oil | | |
| | | | Stevia | | |
| Dark | Sprouted | Dates | Cacao | 8.89 | mg |
| Chocolate | Sunflower | | Stevia | | |
| | Seeds | | | | |
| | Sprouted | | | | |
| | Broccoli | | | | |
| | Seeds | | | | |

### Example 3: Freeze-Dried Embryonic Sprouted Baby Food Product

The present application provides a freeze-dried embryonic sprouted plants food product formulated for baby and infants. In some embodiments, a freeze-dried embryonic sprouted plants food product intended for baby and young children contains a lower percentage of embryonic sprouted plants, compared to fruits and/or vegetables, thereby providing a soft texture with no or minimal crunch.

Table 2 below provides exemplary freeze-dried sprouted food products having embryonic sprouted plants seeds and any combination of fruits and/or vegetables, formulated for baby and young children.

TABLE 2
Freeze-dried embryonic sprouted plants formulated
for baby food and food for young children

| Freeze-Dried | | |
|---|---|---|
| Embryonic Sprouted | Embryonic sprouted | Fruits and/or |
| Plant Food Product | plants | Vegetables |
| Blueberry Baby Food | Sprouted Sunflower Seeds | Blueberry |
| Banana Baby Food | Sprouted Sunflower Seeds | Banana |
| Carrot Baby Food | Sprouted Flax Seeds | Carrot |
| Savory Baby Food | Sprouted Flax Seeds | Bell Pepper |

### Example 4: Freeze-Dried Embryonic Sprouted Animal Food Product

The present application provides a freeze-dried embryonic sprouted plants food product formulated for animals, such as domestic pets and livestock. In some embodiments, a freeze-dried embryonic sprouted plants food product intended for a domesticated dog contains a higher percentage of embryonic sprouted plants, compared to fruits and/or vegetables, thereby providing a crunchy texture. Exemplary dog or pet food include but are not limited to pellet, kibble, biscuit, jerky, and rawhide.

Table 3 below provides exemplary freeze-dried embryonic sprouted food products having embryonic sprouted plants seeds and any combination of fruits and/or vegetables, formulated for domestic pets and livestock.

TABLE 3
Freeze-dried embryonic sprouted plant product for domestic pet and livestock

| Freeze-Dried | | | |
|---|---|---|---|
| Embryonic | | | |
| Sprouted Plant | Embryonic sprouted | Fruits and/or | |
| Food Product | plants | Vegetables | Optional Flavoring |
| Dog biscuit | Sprouted Chia Seeds | Carrot | Yeast |
| | Sprouted Flax Seeds | | |
| | Sprouted Sunflower | | |
| | Seeds | | |
| Pet food jerky | Sprouted Chia Seeds | Sweet Potato | Liquid aminos, soy |
| | Sprouted Flax Seeds | | sauce, liquid smoke |
| | Sprouted Sunflower | | |
| | Seeds | | |

### Example 5: Freeze-Dried Embryonic Sprouted Snack Product

The present application provides a freeze-dried embryonic sprouted plants food product formulated from a whole fruit or vegetable. In some embodiments, a freeze-dried embryonic sprouted plants is used as a coating on a whole fruit or vegetable, such as an apple slice or pickle.

Table 4 below provides exemplary freeze-dried embryonic sprouted snack products having a coating and any combination of fruits, vegetables, formulated for human or animal consumption.

TABLE 4
Snack products having freeze-dried embryonic sprouted plants
formulated for human or animal consumption

| Freeze-Dried | | Embryonic | |
|---|---|---|---|
| Embryonic | Whole Fruits | sprouted | Optional |
| Sprouted Plant | and/or | plants used | Flavoring or |
| Food Product | Vegetables | as Coating | other Coatings |
| Fermented Chip | Carrot, Pickle, | Sprouted | Salt, Pickling |
| | Cabbage, | Chia Seeds | Spices |
| Apple Slice | Apple | Sprouted | Dates, |
| | | Flax Seeds | Probiotics, |
| | | Blueberry | |

### Example 6: Snack

The process of Example 2 is repeated, but the mixture is molded for a snack in a different mold and water content is adjusted accordingly upwards to make the mixture less dense during mixing. A consumer is appreciating the texture, is appreciating the taste of the snack, and is appreciating the mouthfeel. A consumer is describing the snack as crunchy on the outside.

The composition described above is made using the methods described herein. It should be appreciated that the present invention is not limited to the specific embodiments described above, but includes variations, modifications and equivalent embodiments defined by the following claims.

What is claimed is:

1. A composition, comprising a freeze-dried mixture of one or more embryonic sprouted plants and one or more flavorings.

2. The composition of claim 1, wherein the embryonic spouted plants are selected from adzuki, alfalfa, broccoli, buckwheat, cabbage, cauliflower, chia, chives, clover, dill, fenugreek, flax, garbanzo bean, garlic, kale, kidney bean, lentil bean, mung bean, mustard, navy bean, oats, peas, pinto bean, pumpkin, radish, red clover, soy bean, sunflower, wheat berry, and wheat grass.

3. The composition of claim 1, wherein the one or more flavorings is derived from a spice, fruit, fruit juice, cacao, vegetable, vegetable juice, essential oil, edible yeast, herb, bark, bud, root, leaf, meat, seafood, poultry, eggs, dairy products, fermentation products, liquid smoke, or any other natural or artificial flavoring.

4. The composition of claim 1, wherein said composition is a food product for human or animal consumption.

5. The composition of claim 4, wherein said food product is a cereal, snack product, pudding, baby food product, food replacement powder, food replacement product, or animal food.

6. The composition of claim 5, wherein said food product is a pet food selected from pellet, kibble, biscuit, jerky, and rawhide.

7. The composition of claim 1, wherein said freeze-dried mixture comprises embryonic sprouted broccoli seeds.

8. The composition of claim 1, wherein said freeze-dried mixture comprises embryonic sprouted flax seeds and embryonic sprouted chia seeds.

9. The composition of claim 5, wherein said food product is a cereal comprising embryonic sprouted broccoli seeds.

10. A method of making a composition, comprising:
mixing one or more embryonic sprouted plants and one or more flavorings to form a mixture, and thereafter
freeze-drying the mixture.

11. The method of claim 10, further comprising, before the mixing, pureeing the one or more embryonic sprouted plants.

12. The method of claim 10, further comprising, before the freeze-drying, pureeing the mixture.

13. The method of claim 10, further comprising, before the freeze-drying, processing the mixture with one or more steps selected from crushing the mixture, emulsifying the mixture, and masticating the mixture.

14. The method of claim 10, further comprising, before the freeze-drying, the mixture is homogeneous.

15. The method of claim 10, further comprising, after the freeze-drying, the freeze-dried mixture is homogeneous.

16. The method of claim 10, further comprising, before the freeze-drying, molding the mixture.

17. The method of claim 10, further comprising, after the freeze-drying, pulverizing the mixture into a powder.

18. The method of claim 10, further comprising, after the freeze-drying, unmolding the freeze-dried mixture.

19. The method of claim 10, further comprising, before freeze-drying, flash freezing the mixture.

20. The method of claim 10, further comprising, before freeze-drying, molding the mixture.
